(19) United States
(12) Patent Application Publication
(10) Pub. No.: US 2026/0268927 A1
(43) Pub. Date: Sep. 10, 2026

(54) Conversation Analytics For Identifying Conversational Features, and Related Systems, Methods, and Software

(71) Applicant: University of Vermont and State Agricultural College, Burlington, VT (US)

(72) Inventors: Donna Rizzo, Burlington, VT (US); Robert E. Gramling, Burlington, VT (US)

(21) Appl. No.: 19/491,305

(22) PCT Filed: Jun. 12, 2024
(86) PCT No.: PCT/US2024/033534

§ 371 Date: Dec. 8, 2025

Related U.S. Application Data
(60) Provisional application No. 63/507,627, filed on Jun. 12, 2023.

(51) Int. Cl. G10L 25/87; G10L 15/02; G10L 15/16; G10L 25/18; G10L 25/24

(52) U.S. Cl. CPC G10L 25/87; G10L 15/02; G10L 15/16; G10L 25/18; G10L 25/24

(57) ABSTRACT

Methods of outputting indications of predicted pauses in conversations transformed into acoustical data. In an example, such methods include receiving the acoustical data in two or more differing forms, processing each form with a corresponding form classifier to generate a corresponding pause-prediction output, fusing the pause-prediction outputs with one another so as to generate an aggregated prediction of the predicted pause, and outputting, as a function of the aggregated prediction, an indication of the predicted pause. Methods of classifying characterizations of predicted pauses are also disclosed. In some embodiments, such methods include recording a conversation to create audio data, processing the audio data to identify a predicted pause, analyzing one or more portions of the audio data adjacent to the predicted pause using a lexical analyzer to classify a characterization of the predicted pause, and outputting the characterization. Other methods, as well as related software and system are also disclosed.

### RELATED APPLICATION DATA

This application claims the benefit of priority of U.S. Provisional Patent Application Ser. No. 63/507,627, filed Jun. 12, 2023, and titled “CONVERSATION ANALYICS SYSTEMS FOR IDENTIFYING CONVERSATIONAL FEATURES”, which is incorporated by reference herein in its entirety.

### FIELD

The present disclosure generally relates to the field of conversation analytics. More particularly, this disclosure is directed to conversation analytics for identifying conversational features, and related systems, methods, and software.

### BACKGROUND

Fostering human connection is fundamental to good communication in various settings, such as clinical settings. Unfortunately, this happens infrequently in modern healthcare, particularly in clinical settings in which serious and life-threatening illness is being addressed. Re-engineering healthcare will require systematic measurement and feedback about the quality of human connection in routine clinical interactions. Existing methods of conversation analytics are too cumbersome for effective use in the largescale epidemiological studies in natural clinical settings necessary to guide implementation of such quality metrics.

### SUMMARY

In one implementation, the present disclosure is directed to a method of outputting an indication of a predicted pause in a conversation transformed into acoustical data. The method includes receiving a plurality of forms of the acoustical data, wherein the forms are of differing types; processing each of the plurality of forms with a corresponding form classifier so as to generate a corresponding plurality of pause-prediction outputs; fusing the plurality of pause-prediction outputs with one another so as to generate an aggregated prediction of the predicted pause; and outputting, as a function of the aggregated prediction, an indication of the predicted pause to a conversation analytics system.

In another implementation, the present disclosure is directed to a method of classifying a pause in a conversation transformed into acoustical data. The method includes processing each of a plurality of differing forms of the acoustical data with a corresponding form classifier so as to generate a corresponding plurality of pause-prediction outputs; fusing the plurality of pause-prediction outputs with one another so as to generate a temporal location of a predicted pause within the conversation; generating lexical data for a pre-pause segment of the conversation temporally adjacent to the predicted pause; processing the lexical data with a lexical classifier to determine a predicted pause type for the predicted pause; and outputting the predicted pause type to a conversation analytics system.

In yet another implementation, the present disclosure is directed to a method, which includes recording a conversation between at least two people to create audio data; processing the audio data with one or more form classifiers to identify a predicted pause in the conversation; analyzing one or more portions of the audio data adjacent to the predicted pause using a lexical analyzer to classify a characterization of the predicted pause; and outputting the characterization to conversation analytics system that uses the characterization to provide information about the conversation to a user.

In still another implementation, the present disclosure is directed to a computer-readable storage medium containing computer-executable instructions for performing any of the methods listed directly above.

### BRIEF DESCRIPTION OF THE DRAWINGS

For the purpose of illustration, the accompanying drawings show aspects of one or more embodiments of the disclosure. However, it should be understood that the scope of this disclosure is not limited to the precise arrangements and instrumentalities shown in the drawings, wherein:

FIG. 1 is a high-level diagram of an example conversation analytics system made in accordance with the present disclosure;

FIG. 2 is a high-level diagram of an example implementation of the conversation analytics system of FIG. 1 for a healthcare setting;

FIG. 3 is a graph showing examples of what percentage of lexicon that precedes Emotional Connectional Silences, Invitational Connectional Silences, and Non-Connectional Silences falls into certain categories of speech, such as future-tense speech and past-tense speech;

FIG. 4A is a spectrogram showing spectral data from 10-seconds of example audio;

FIG. 4B shows two-second frames of spectral data extracted from the spectrogram in FIG. 4A;

FIG. 5 is a high-level diagram of an example of a Convolutional Neural Network (CNN) classifier;

FIG. 6 is a graph showing an example of CNN training accuracy and CNN validation accuracy plotted against training epochs;

FIG. 7 is a high-level diagram showing an example of the process of converting CNN output probabilities into predictions with 0.5-second resolution;

FIG. 8 is a an example of a receiver operating characteristic (ROC) curve showing the tradeoff between sensitivity and False Discovery Rate;

FIG. 9 is a graph showing an example of training accuracy and validation accuracy plotted against training epochs for an example Bidirectional Encoder Representations from Transformers (BERT) classifier; and

FIG. 10 is a diagrammatic representation of a computer system that may be used to perform differing functions of various aspects of any of the methods of the present disclosure.

### DETAILED DESCRIPTION

### I. General

In some aspects, the present disclosure is directed to computer-implemented methods of automatedly predicting locations of pauses in a conversation, for example, connectional pauses that have been identified as often relating to emotions of at least one of the participants in the conversation. For example, and as discussed below, in healthcare settings, for example, in palliative care and care of serious illness, certain connectional pauses between a healthcare provider and a patient can indicate emotional discomfort (e.g., distress, concern, etc.), and methods of the present disclosure can not only reliably predict locations of candidate pauses in such a conversation but some methods can characterize a predicated pause in terms of type, including species types and subspecies types. Example pause characterizations are provided below. While healthcare settings are a prime use for methods of the present disclosure, such methods can be used in other settings, such as, for example, conflict resolution, diplomacy/debate, legal mediation, educational settings (e.g., academic advising, instruction by example, etc.), and/or any type of setting wherein at least one of the participants in the conversation may have one or more emotional reactions to the conversation.

As will be readily understood by those skilled in the art, methods disclosed herein and apparent to a skilled person include computer-implemented methods that are executed in corresponding software and may be performed in the context of any one or more suitable systems, such as a pause predicter, a lexical processor, and/or a conversation analytics system. As used herein, the term “system,” depending on context, means either a software system or a software-hardware system. A “software system” is a collection of software modules, code segments, routines, code, etc., that perform differing functions of the various aspects of any of the methods of the present disclosure. A hardware-software system is a combination of a hardware system with one or more pieces of hardware, such as, but not limited to, a smartphone, a tablet computer, a laptop computer, a desktop computer, one or more web servers, a cloud-computing hardware, and/or a dedicated hardware device, among others.

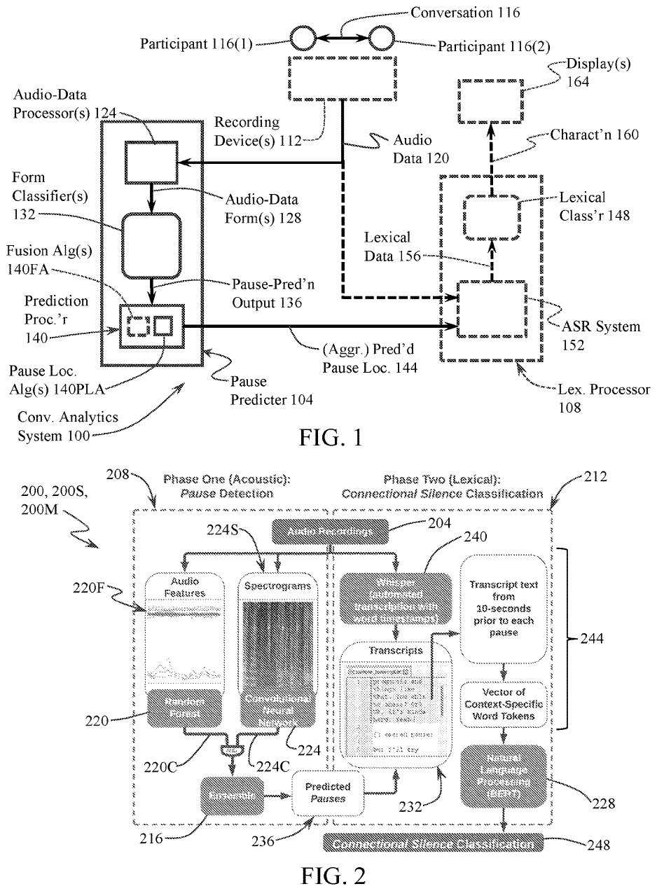

Turning now to the drawings, FIG. 1 illustrates an example conversation analytics (CA) system 100 made in accordance with various aspects of the present disclosure. In this example, the CA system 100 includes a pause predicter 104 and an optional lexical processor 108, each of which may be characterized as a software system due to each having performing multiple functions within the respective methods. CA system 100 may also optionally include one or more recording devices 112 for recording a conversation 116 between at least two participants 116(1) and 116(2). More than two participants 116(1) and 116(2) may be present in the conversation 116 if/when appropriate. In an example, the participant 116(1) is a healthcare worker, the participant 116(2) is a patient, and the conversation 116 concerns health of the patient. In another example, the participant 116(1) is an advisor, the participant 116(2) is an advisee, and the conversation is an academic-advising session. In another example, the participant 116(1) is a teacher, the participant 116(2) is a student, and the conversation is a learning session. The participants 116(1) and 116(2) in another type of conversation 116 will be self-evident. Each recording device 112 may be any suitable recording device 112 that generates audio data 120 of any suitable type, either analog or digital, and the analog audio data, if any, can be readily converted into digital audio data as needed. Each recording device 112 may have any component known in the art of digital audio recorders, such as a microphone, audio filters, an analog to digital converter, data storage, and associated controllers or processors.

In this example, the pause predictor 104 includes one or more audio-data processors (singly and collectively indicated at 124) for creating one or more audio-data forms (singly and collectively indicated at 128), such as a spectrograph form or an audio-feature form. The audio-data processor 124 performs one or more preprocessing functions on the recorded audio data, such as filtering, removing segments, anonymizing, and/or splitting the audio data into consecutive overlapping or non-overlapping segments for feature generation and classification. In one embodiment, the audio-data processor 124 may be a filter cascade model. In other embodiments, additional or alternative techniques or models may be used to extract, generate, or create features according to the recorded conversation 116. Non-limiting examples of features include pitch, beat-related descriptors, note onsets, fluctuation patterns, and MFCC coefficients, among others.

In one embodiment, the audio-data processor 124 generates 85 audio features which include 5 summary statistics of 13 Mel-Frequency Cepstral Coefficients (MFCCs), zero-crossing rate, energy, energy entropy, and spectral entropy.

In some embodiments, the audio-data processor 124 may generate audio features that reflect or measure pitch based on how the human ear perceives sound.

In some embodiments, the audio-data processor 124 is based on the physiology of the human ear. The audio-data processor 124 may divide the input sound into multiple frequency channels, and include a cascade of multiple filters (with gain control coupled to each filter). Each filter filters out a particular range of frequencies or sounds, and the (numerical) outputs from these various filters are used as the basis for the features, which are used by an audio feature pause classifier to classify the speech sounds in the segment.

In some embodiments, the audio-data processor 124 is a Cascade of Asymmetric Resonators with Fast-Acting Compression (CARFAC) model. The CARFAC model is based on a pole-zero filter cascade (PZFC) model of auditory filtering, in combination with a multi-time-scale coupled automatic-gain-control (AGC) network. This mimics features of auditory physiology, such as masking, compressive traveling-wave response, and the stability of zero-crossing times with signal level. The output of the CARFAC model (a “neural activity pattern”) can be converted to capture pitch, melody, and other temporal and spectral features of the sound.

In some embodiments, the audio-data processor 124 may use another model, such as a spectrogram modified by a mel filter bank. The model utilizes mel-frequency cepstral coefficients (MFCCs) as the extracted features of the audio data. MFCCs represent a power spectrum of the audio based on a perceptual scale of pitches, known as the mel scale.

In some embodiments, at least two audio-data forms 128 of differing types are used to improve the performance of the pause predicter 104 in accurately predicting pauses in the conversation 116. In an example and as discussed below, accuracy has been increased by using both a spectrograph form and an audio-feature form.

The pause predicter 104 also includes one or more form classifiers 132 for generating one or more pause-prediction outputs (singly and collectively indicated at 136), which is/are then provided to a prediction processor 140. Each of the one or more form classifiers 132 may be any suitable classifier, such as a machine learning (ML) classifier. Examples of suitable ML classifiers suitable for use as a form classifier 132 include, but are not limited to supervised classifiers such as, Artificial Neural Network (ANN) classifiers (e.g., Convolutional Neural Network (CNN) classifiers), decision tree classifiers (e.g., Random Forest (RF) classifiers), k-Nearest Neighbor (kNN) classifiers, naïve Bayes classifiers, perceptron classifiers, regression classifiers (e.g., linear and logistic), and vector machine classifiers (e.g., Relevance Vector Machine (RVM) classifiers and Support Vector Machine (SVM) classifiers), among others. Fundamentally, there is no limitation on the type(s) of classifier(s) 132 used other than that each needs to be compatible with the corresponding one of the audio-data form(s) 128.

Each form classifier 132 generates a suitable pause-prediction output 136 that is then provided to a prediction processor 140. Each pause-prediction output 136 may be in any suitable form, such as a raw score (e.g., probability from 0 to 1, a percentage likelihood, etc.) or other score indicating the likelihood that the conversation contains a corresponding pause at the classified location in the conversation 116. Each form classifier 132 may be trained on suitable training data (not shown) that contains data instances of pauses (in the appropriate type of form data) that the classifier is designed to predict. In some examples, each form classifier 132 is trained or otherwise configured to predict pauses of a certain minimum time duration, such as from about 1.5 seconds to about 3 seconds and longer, wherein “about” indicates +/−20%, +/−10%, +/−5%, or +/−0%, depending on the situation. In some examples, each form classifier 132 is trained or otherwise configured to predict pauses of a certain maximum time duration, such as equal to or shorter than about 8 seconds to about 10 seconds, with “about” having the same meaning as noted above. These pause durations are merely examples and can be different for other embodiments and/or conversation type. For example, regarding conversation types, each minimum and maximum duration can be based on the types of pauses expected during a particular type of conversation, such types of pauses being functions of the types of emotions that the conversation type is known to elicit from at least one of the participants 116(1) and 116(2).

Depending on the number of form classifiers 132 and corresponding pause-prediction outputs 136, the prediction processor 140 provides a function of generating a predicted-pause location 144 within the conversation 116 and the corresponding audio data 120. When only one audio-data form 128 is used, the prediction processor 140 may determine whether or not the pause-prediction output 136 of the form classifier 132 satisfies the criterion(ia) for predicting a pause and, if so, may include one or more pause-location algorithms 140PLA that determine the location of the predicted pause within the conversation 116 and/or the audio data 120. In this example, knowing the location of the predicted pause within the conversation 116 and/or the audio data 120 allows the example conversation analytics system 100 to characterize the predicted pause.

When two or more audio-data forms 128 are used, the prediction processor 140 may use one or more fusion algorithms 140FA to fuse the pause-prediction outputs 136 of the corresponding form classifiers 132 to determine an aggregated version of the predicted pause location 144, referred to herein and in the appended claims as an “aggregated pause location.” As mentioned above, the accuracy of predicting pauses can be enhanced by using two (or more) forms of the audio data 120. The fusion algorithm(s) 140FA may include, among other things, weights for the differing pause-prediction outputs 136 and/or one or more converters to convert one or more of the outputs to a common format for fusion. Those skilled in the art will understand how to implement any suitable fusion algorithm(s) 140FA needed. In one example, the prediction processor uses pause location algorithm(s) 140PLA after executing the fusion algorithm(s) 140FA.

As mentioned above, in this example the conversation analytics system 100 includes the lexical processor 108, which performs additional processing that characterizes a predicted pause. In the embodiment shown, the lexical processor 108 includes a lexical classifier 148 and an Automated Speech Recognition (ASR) system 152 to convert spoken words in the conversation 116 and the audio data 120 into lexical data 156 that the lexical classifier uses to determine a characterization 160 of the predicted pause. Like the form classifier(s) 132 discussed above, the lexical classifier 148 may be any suitable classifier configured to handle the lexical data 156, such as a Natural Language Processing (NLP) classifier, for example, a Bidirectional Encoder Representations from Transformers (BERT) classifier. The ASR system 152 may comprise any suitable ASR system, such as, but not limited to, the WHISPER™ ASR available from Open AI, San Francisco, California. In an example, the ASR system 152 can utilize timestamps, which allows the (aggregated) predicted pause location 144 to be coordinated with the locations of spoken words within the conversation 116 and the corresponding audio data 120.

Depending on the type(s) of characterization 160 that the lexical processor 108 is designed to output, the ASR system 152 may process only a limited amount of the conversation 116 (audio data 120). For example, the ASR system 152 may be configured to process a fixed pre-pause time-period of the audio data 120 immediately prior to the predicted pause and/or a fixed post-pause time-period of the audio data immediately following the predicted pause. Alternatively, the ASR system 152 may be configured to process a fixed number of pre-pause words immediately preceding the predicted pause and/or a fixed number of post-pause words immediately following the predicted pause. The lengths of any pre-pause and post-pause time-periods and the numbers of any pre-pause and post-pause words selected will typically be dependent on the type(s) of pause characterizations that the characterization 160 can be.

The nature of the words spoken in the conversation 116 immediately prior to the predicted pause, alone or in combination with the nature of the words immediately after the predicted pause, can predict a characteristic of the predicted pause. For example, certain words directed to a medical treatment, life expectancy, quality of life, etc., spoken in a medical setting may cause certain emotional, pensive, trepidatious, etc., responses in a patient that can be a root cause of the predicted pause. For such a setting, the lexical processor 108 of FIG. 1 may be configured to look for such words proximate to the predicted pause. In some embodiments, the lengths of the pre- and post-pause time-periods may be in a range of about 8 seconds to about 25 seconds or the number of pre- and post-pause words may be in a range of about 5 words to about 15 words, with “about” in each of these having the meaning defined above. These values are merely illustrative, and other values may be used. In addition, when both pre- and post-pause time-periods or words are used, the pre-pause and post-pause values may be the same as one another or different from one another. Examples of characterizations that the characterization 160 may be include, but are not limited to, an extent of human connection between the two people, a quality of the human connection, an indication of a connectional silence, a type of a connectional silence, a connectional silence score, and a clinically important feature of the conversation, among others. Some particular characterizations are described in the following section relative to a healthcare implementation.

The conversation analytics system 100 of this example further includes one or more displays (singly and collectively indicated at 164), each of which displays the characterization 160 of the predicted pause. Each display 164 may be the visual display of any suitable electronic device, such as, but not limited to, a smartphone, a tablet computer, a laptop computer, a desktop computer, one or more web servers, a cloud-computing hardware, and/or a dedicated hardware device, among others. As those skilled in the art will readily appreciate, each display 164 may display the characterization 160 in any suitable manner, such as in text (not shown), an emoticon, and/or in another form.

In some embodiments, elements of the CA system 100 may be in communication over a network. The network may include any communication topologies and protocols known in the art, such as the Internet, a LAN, a MAN, a WAN, a mobile, wired or wireless network, a cloud computing network, a private network, or a virtual private network, and any combination thereof. In addition, all or some of the links of the network can be encrypted using conventional encryption technologies such as the secure sockets layer (SSL), Secure HTTP, and/or virtual private networks (VPNs). In another embodiment, the entities can use custom and/or dedicated data communications technologies instead of, or in addition to, the foregoing.

Such an architecture can provide a number of advantages. For example, anonymization and protection of patient information can be more easily realized by only transmitting limited segments of a recorded conversation 116. For example, a pause predicter 104 may be implemented on a local computing device located where the conversation 116 occurs, while an optional lexical processor 108 may be located remotely, such as in a cloud-based system. In some embodiments, the pause predicter 104 may be implemented locally in hardware and software, such as a mobile phone, tablet, laptop, or specially designed computing device, and only limited segments of the recorded conversations are transmitted from the pause predictor 104 to the cloud for natural language processing and scoring. Elements of the CA system 100 may also be distributed in any number of other combinations of locations while still achieving the functions disclosed herein.

While FIG. 1 depicts the example CA system 100 with certain discrete elements, those skilled in the art will readily appreciate that this particular depiction is done for convenience to focus on the various functionalities. In other embodiments, one or more of the discrete elements shown may be combined into another type of element that performs the same functionalities but is structured differently.

### II. Detailed Healthcare Example

### II.A Overview

With the foregoing generalities in mind, the example of this section is designed and configured for healthcare communication science and quality improvement. Methods, software, and systems of this example automate the characterization of conversational features of a conversation between a patient and a healthcare provider, such as one or more types of Connectional Silences, in recorded conversations that have been associated with important patient outcomes.

In this example, an automated pipeline processes audio and lexical data based on audio recordings from a well-known Palliative Care Communication Research Initiative (PCCRI) cohort study. As discussed below, this automated pipeline utilizes three ML tools, namely an RF classifier and a custom CNN classifier that operate in parallel with one another on two different forms of audio data from the audio recordings, and a downstream NLP classifier that uses brief excerpts of automated speech-to-text transcripts of the audio recordings that are provided by an ASR system.

Results: The implementation of the automated pipeline described below identified Connectional Silence with an overall sensitivity of 84% and specificity of 92%. For Emotional and Invitational subtypes, sensitivities of 68% and 67%, and specificities of 95% and 97%, respectively, were observed. Systems of the present disclosure allow for coordinated and complementary ML methods to fully automate the characterization of one or more types of conversational features, such as ConnectionalSilences, in natural hospital-based clinical conversations and provide one or more metrics that assess characteristics of the conversation.

### II.B Example Clinical Conversations

Defining directly-observable characteristics of clinical conversations that reliably mark moments of human connection can be challenging, because the ways in which connection can be felt by conversation participants are many and varied. Despite these empirical measurement considerations, directly-observable moments of human connection between patients and their clinicians often arise in or around some of the pauses in a conversation, such as when people cease talking to honor the gravity of what is being discussed or to provide sufficient time for a seriously ill person to contemplate a response to a meaningful question. Previous research has shown that Connectional Silences during clinical conversations are associated with improvement in seriously ill patients' self-reported quality-of-life and with treatment decision-making that honors their values.

Identifying Connectional Silences in audio recordings of conversations using traditional methods is highly labor intensive and requires skilled human coders. Aspects of the present disclosure include computer-implemented systems and methods for fully automating the identification of conversational features, such as Connectional Silences, and in some examples, automatically generating one or more clinical interaction quality metrics that assess a quality, or characterization, of the conversation. In some examples, the methods utilize speech prosody and lexicon.

### II.C Experiment Participants and PCCRI Study Design

The PCCRI is a descriptive cohort study of naturally-occurring specialty palliative care consultations performed at two academic medical centers on the West Coast and in the Northeast, both of the United States. As part of the study, researchers recorded the initial consultation and up to two follow-up visits between 231 hospitalized persons with advanced cancer, their families (if present), and palliative care specialists (in total, 54 clinicians participated in the study). The criteria for participant inclusion in the study were a diagnosis of metastatic cancer, English speaking, 21 or more years of age, and the ability to consent for participation in the research or have a health care proxy who was able to consent. Patients with a “comfort measures only” designation on their medical orders or who were already receiving hospice care were ineligible.

Each conversation was recorded on an omnidirectional, hand-held digital recorder placed in an unobtrusive location in the patient's hospital room. Identifying participant information was removed from the audio files, but no effort was made to modify ambient sounds from the natural environment, which included hospital announcements, equipment beeping, TV/radio audio, and background conversations at the nurses' station and adjacent beds.

### II.C “Ground Truth” Definition of Pauses and Connectional Silences

In the present example, a Pause was defined as a two-second or longer duration of time when no conversation participant made an audible attempt to hold or attain the speaking floor. The two-second minimum duration was used to align with previous work that identified this threshold as nearly culturally ubiquitous. As noted above relative to the conversation analytics system 100 of FIG. 1, in other examples methods and systems of the present disclosure may be configured to identify pauses of durations that are longer or shorter than about two seconds.

For the experiment reported here, two sub-types of Connectional Silence following the conceptual work of others were used:
a. Emotional Connectional Silence: A Pause that follows a moment of gravity in the conversation, including either an expression of an emotion that seems unpleasant (e.g., anger, fear, or sadness) or information that the speaker seems to perceive as unfavorable (e.g., prognosis).
b. Invitational Connectional Silence: A Pause that occurs after a question relating to one of the following: personal values or identity; quality of life; treatment hopes, goals, or preferences; prognosis; or death/dying.

In the herein-reported experimentation, three non-overlapping classes of Pauses were utilized: Emotional Connectional Silences, Invitational Connectional Silences, and Non-Connectional Pauses (defined as any other moments considered to be Pauses). In one example, one or more trained human coders were used to independently identify Pauses; any disagreements were adjudicated by a third coder. Predicted Pauses can be coded as an Emotional Connectional Silence, an Invitational Connectional Silence, or a Non-Connectional Pause, according to our definitions of these classes. To make this judgment for each Pause, human coders listened to an audio clip comprising the Pause, a period of time (e.g., approximately 10 seconds) directly preceding the Pause, and a period of time (e.g., approximately five seconds) directly following the Pause. The human coder(s) then classified the Pause, for example, as a Connectional Silence (Emotional or Invitational).

### II.D Experimental ML Pipeline

FIG. 2 illustrates, in hybrid fashion, a system 200S and a corresponding method 200M that formed the ML pipeline 200, which were used in the experimentation of this example for identifying conversational features in the PCCRI conversations recorded in a set of audio recordings 204. In the illustrated example, the method 200M included two phases, namely a Phase One 208 and a Phase Two 212, and used three ML classifiers. In Phase One 208, a pause-detection classifier ensemble 216 composed of an RF classifier 220 and a CNN classifier 224 was used to create two classification outputs 220C and 224C, respectively. The RF classifier 220 was an audio feature pause classifier designed, configured, and trained to classify and predict pauses of clinical significance based on audio features 220F. The CNN classifier 224 was an audio image pause detection classifier that was also designed, configured, and trained to classify pauses of clinical significance based on spectrograms 224S. In Phase Two 212, a BERT classifier 228 was designed, configured, and trained to classify a pause in a conversation according to one or more connectional silence types based on transcripts 232 of the audio recording 204.

In Phase One 208, the pause-detection classifier ensemble 216 processed the audio recordings 204 to identify pauses of about a two-second minimum duration and output the classification outputs 220C and 224C, which were then fused with one another to provide a set of predicted pauses 236. In Phase Two 212, the predicted pauses 236 were used in conjunction with an ASR system 240 to create the transcriptions 232 composed of portions of the conversation proximate the predicted pauses. In the herein-reported experimentation, the ASR system 240 transcribed approximately 10 seconds of conversation preceding each predicted pause 236 to create corresponding sets of lexical data 244. The BERT classifier 228 then processed the lexical data 244 to classify each predicted pause 236 according to whether the predicted pause 236 represents an occurrence of Connectional Silence and outputted a corresponding connectional silence classification 248, for example to one or more output devices (not shown, but see display(s) 164 of FIG. 1).

The performance of the complete ML pipeline 200 was assessed on the 203 of the 231 conversations for which all types of conversational pauses had been rigorously human-coded. Conversations from 28 participants were excluded because establishing the “ground truth” upon which to evaluate the pipeline performance was unreliable due to obscured patient voice (e.g., whispering while wearing high flow oxygen mask), substantial non-audible methods of communication, (e.g., white board, gestures) or non-audible key conversation participant (e.g., clinician speaking with family member via telephone not using the speaker). The following standard epidemiological and natural language processing measures of test performance were determined: sensitivity (a.k.a. recall), specificity, positive predictive value (a.k.a. precision), negative predictive value, and F1. Further details of the ML pipeline 200 appear below.

### II.D.1 Phase One (Acoustic)

To identify the presence of a Pause, the RF classifier 220 and the CNN classifier 224 independently classified sequential intervals, e.g., 0.5-second intervals, of audio recordings 204 into “speech” or “non-speech” using very different types of acoustical features extracted from the same audio recordings 204. In an example, a first classifier, here, the RF classifier 220, was utilized that was configured to use a set of 85 audio features comprising five summary statistics of 13 Mel-Frequency Cepstral Coefficients (MFCCs—a subjective scale for measuring pitch based on how human observers perceive sound), zero-crossing rate, energy, energy entropy, and spectral entropy. As described more herein, in other examples the first classifier may utilize additional or alternate features and may employ alternate architectures or algorithms.

The second classifier, here, the CNN classifier 224, directly evaluated the spectrograms 224S. As described more herein, a variety of image-based audio features may be utilized and alternate architectures and algorithms to the specific CNN classifier 224 disclosed may be used.

As shown in FIG. 2, the classification outputs 220C and 224C from the RF classifier 220 and the CNN classifier 224 were then be combined by retaining only the 0.5-second intervals wherein both the RF and CNN classifiers agreed that no speech is present (unanimous voting). Consecutive 0.5-second intervals determined by both the RF classifier 220 and CNN classifier 224 as lacking any speech were then merged, and merged regions that are two seconds or longer were defined as predicted pauses 236. Additional information on the training, validation, and testing of the CNN classifier 220, the RF classifier 224, and the method 200M are discussed below.

### II.D.2 Phase Two (Lexical)

In the example, the BERT classifier 228 was used as a NLP classifier for classifying the predicted pauses 236 according to whether the pause represents a moment of Connectional Silence. The BERT classifier 228 was pre-trained on large volumes of English-language data in order to allow for efficient refinement on smaller sets of contextually specific data, such as the recorded clinical conversations discussed here.

Ten second excerpts (in lexical data 244) of each recorded conversation immediately preceding predicted pauses 236 were processed by the BERT classifier 228 for classification. Transcripts 232 for use by the BERT classifier 228 were generated by an ASR system 240, here the WHISPER™ speech recognition system. The time durations of the excerpts of each transcript 232 were selected to align with the ground truth data (the data used by human coders to manually classify pauses). To minimize algorithmic bias, the BERT classifier 228 was trained on a balanced subset of text excerpts directly preceding Invitational Connectional Silences, Emotional Connectional Silences, and Non-Connectional predictions. The trained and cross-validated BERT classifier 228 was used to classify all predicted pauses 236 into one of the three classes of pauses. Details on the training, validation, and testing of the BERT classifier 228 are discussed below.

### II.D.3 Lexical Comparison of Pipeline Predictions

To explore the lexicon from the lexical data 244 that the BERT classifier 228 used for classifying the predicted pauses 236, the proportions of words in this text were calculated from clinically relevant corpora (specifically, temporal referents; uncertainty terms; loneliness; symptom, treatment, and prognosis terms; and pronouns). All text associated with each BERT-predicted class was merged into a single block. The word usage proportion for each corpus was calculated as the number of in-corpus words divided by the total number of words for each class. For comparison purposes, word usage proportions for the complete transcripts 232 were also calculated.

### II.E Results

Sample characteristics are shown in Table 1, below, and represent the approximate distribution of age, gender, race, ethnicity, and educational completion of the palliative care consultation population at each study site.

TABLE 1

| Characteristic | n (%) |
|---|---|
| All Patient-Participants | 203 (100) |
| Age | |
| <55 yrs | 50 (25) |
| 55-70 yrs | 83 (41) |
| >70 yrs | 70 (34) |
| Gender | |
| Men | 98 (48) |
| Women | 105 (52) |
| Non-Binary | 0 |
| Education Completed | |
| Bachelor's Degree or higher | 54 (27) |
| Some College | 56 (28) |
| High School or GED | 59 (29) |
| Less than H.S. | 33 (16) |
| Black/AA Race? | |
| Yes | 29 (14) |
| No | 174 (86) |
| Hispanic Ethnicity? | |
| Yes | 14 (7) |
| No | 189 (93) |
| Global Quality of Life* | |
| Low (0-3) | 75 (37) |
| Moderate (4-6) | 63 (32) |
| High (7-10) | 62 (31) |

*McGill Quality of Life Global Item asked pre-consultation (0-10 scale); strata not summing to 203 represent item non-response

The complete ML Pipeline 200 identified Connectional Silence with an overall sensitivity (recall) of 84% (453/539) and specificity of 92% (115,492/124,947), as shown in Table 2A, below. Among all two-second intervals of audio recordings 204 evaluated by the ML Pipeline 200, the prevalence of Connectional Silence was only 0.4% (539/125,486), contributing to a high negative predictive value (>99.9%; 115,492/115,578) and low positive predictive value (precision) (5%; 453/9,908), and F1 (9%; 906/10,447), in this context.

TABLE 2A

| | | Ground Truth | | |
|---|---|---|---|---|
| | | Connectional | Non- | |
| | | Silence | Connectional | |
| ML | Connectional | 453 | 9,455 | 9,908 |
| Pipeline | Silence | | | |
| | Non- | 86 | 115,492 | 115,578 |
| | Connectional | | | |
| | | 539 | 124,947 | 125,486 |

For the Emotional Connectional Silence subtype, a sensitivity (recall) of 68% (207/304), specificity of 95% (119,338/125,182), negative predictive value of >99.9% (119,338/119,435), positive predictive value (precision) of 3% (207/6,051) and F1 of 7% (414/6,355) were observed, as shown in Table 2B, below. For the Invitational Connectional Silence subtype, a sensitivity (recall) of 67% (157/235), specificity of 97% (121,551/125,251), negative predictive value of >99.9% (121,551/121,629), positive predictive value (precision) of 4% (157/3,857), and F1 of 8% (314/4,092) were observed.

TABLE 2B

| | | Ground Truth | | | |
|---|---|---|---|---|---|
| | | | | Non- | |
| | | Emotional | Invitational | Connectional | |
| ML | Emotional | 207 | 46 | 5,798 | 6,051 |
| Pipeline | Invitational | 43 | 157 | 3,657 | 3,857 |
| | Non- | 54 | 32 | 115,492 | 115,578 |
| | Connectional | | | | |
| | | 304 | 235 | 124,947 | 125,486 |

Results for one example implementation of Phase One 208 (predicting pauses) and Phase Two 212 (classifying types of predicted pauses 236) are provided below.

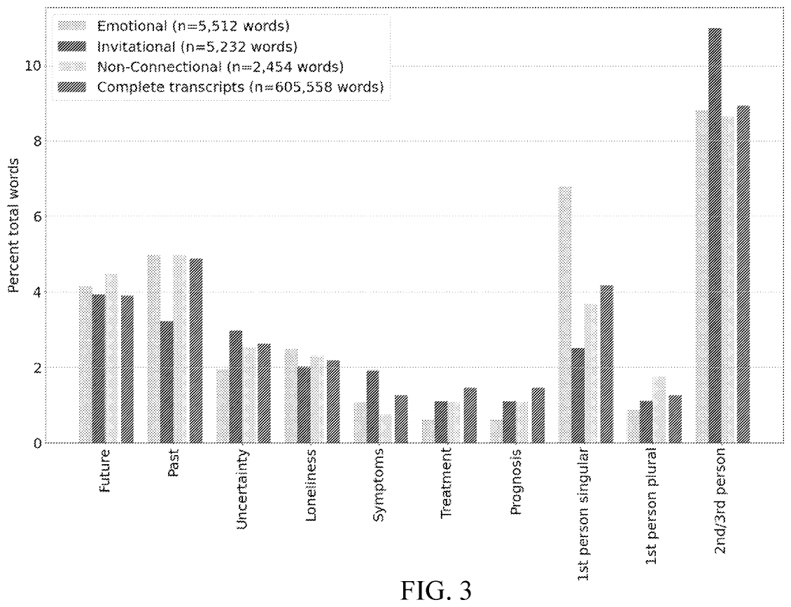

As shown in FIG. 3, the lexicon preceding Emotional Connectional Silences included relatively more past speech than future speech, while the Invitational subtype has relatively more future speech than past speech. Compared to the Invitational sub-type, the Emotional sub-type included more first-person singular pronouns, past-tense speech, and loneliness words, but less future-tense speech and fewer uncertainty, symptom, treatment, and prognosis words. All of the above comparisons were statistically significant (chi-square p<0.001).

### II.F Discussion

Epidemiologically, the presence of Connectional Silence in serious illness conversations is associated with important patient reported outcomes, including improvement in quality-of-life and preference-concordant treatment decisions. In this work, a ML Pipeline 200 of acoustic and lexical algorithms to automatically detect Connectional Silences from audio of real-life serious illness conversations in hospital settings was developed. The ML Pipeline 200 worked very well, missing very few moments of Connectional Silence while maintaining high specificity in categorizing types of automatically identified Pauses. This ML Pipeline 200 offers timely and important scientific innovation to study the epidemiology of Connectional Silence in large-scale natural clinical environments. As shown herein, transformation of the same acoustic signal into multiple data types (e.g., MFCCs, spectral images, and lexical transcripts) can be quite valuable for ML performance in conversation analysis.

In some examples, the ensemble approach, combining a first classifier, here, the RF classifier 220 designed to classify according to a first group of audio features with a second classifier, here, the CNN classifier 224 designed to classify according to a second group of audio features, into the pause-detection classifier ensemble 216 performs better than either method used individually. Specifically, the coordinated ML analyses of distinct forms of sound representation in the pause-detection classifier ensemble 216 resulted in over 3,000 fewer false predicted pauses 236 than the RF classifier 220 alone, and almost 9,000 fewer false predicted pauses 236 than the CNN classifier 224 alone, while only sacrificing the detection of 1.6% of the Connectional Silences. Thus, using the pause-detection classifier ensemble 216 for pause prediction saved an estimated human-coder time for pause classification of about 23 hours over the RF classifier 224 alone.

The ASR system 240 was used to produce brief (e.g. 10 second) excerpts of transcript lexicon (in the lexical data 244) for classification by the BERT classifier 228. Large differences can exist in the lexicon preceding distinct types of pauses. Also, while transcription algorithms have increasingly low error rates, even many state-of-the-art transcription services make word-level errors nearly twice as frequently when evaluating voices from Black compared to White speakers. As such, in some examples careful attention to algorithmic fairness is made when considering automated transcription which may include testing in sufficiently large and diverse samples of participants, settings, and clinical situations to evaluate stratum-specific classification performance and direction of error. And linguistic and ethnographic evaluation of individual classification errors is done to discover, describe, correct, and minimize sources of racial and ethnic bias.

### II.F.1 Cleaning and Labeling Audio Files for CNN Training/Validation

While the RF classifier 220 performed well (i.e., 88.7% sensitivity, and 98.2% specificity), locating the Pause start/end times proved challenging for this algorithm. The RF classifier 220 occasionally identified multiple closely paced Pauses as a single predicted pauses 236, and conversely, occasionally identified multiple predicted pauses 236 within a single larger Pause. To avoid training a CNN classifier that merely replicated the performance of the RF classifier 220, a subset of the predicted pauses 236 from the RF classifier on the Acoustic Training/Testing Data (which comprised 52 conversations from 31 patients) was human-validated. This human-validation effort included confirming the locations of all two-second or longer Pauses in the audio recordings 204, adjusting the start and end times of the predicted pauses 236 identified by the RF classifier 220, and splitting or merging ones of the predicted pauses to match the timings heard in the audio file to +/−0.25-second. These cleaned and labeled audio files were used to train and cross-validate the CNN classifier 224.

II.F.2 Extracting Spectral Data from Audio

Spectral data was extracted from audio recordings 204 with a spectrogram generator; here, a Librosa Python package. A bank of 300 triangular bandpass filters, each normalized by the filter's band width, was used to separate the Mel frequency scale into 300 bins. The 300 filters were placed between 36 Hz and 4 kHz because visual inspection of the spectrograms 224S showed most human speech to occur in this range. Twenty-four sets of filter outputs were extracted per second of audio recordings 204 and converted to decibel values using a constant reference value and stored in .csv files.

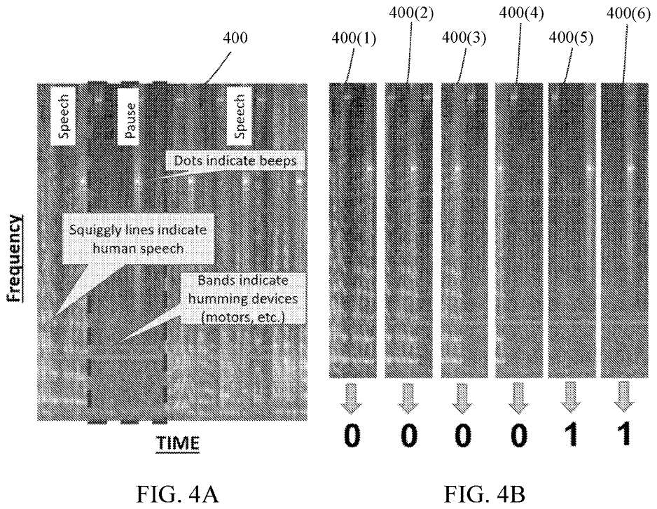

In FIG. 4A, spectral data from a 10-second sample of audio is displayed as a spectrogram 400. During training and testing of the CNN classifier 224, the audio interval (.csv file) in question was loaded and normalized using the minimum and maximum decibel values associated with that specific health care conversation 116. Time is along the x-axis and frequency is on the y-axis. Pixel brightness indicates frequency magnitude at an instant in time. The horizontal bands of brighter pixels to the left and right sides of the spectrogram are characteristic of human speech; different speakers exhibit different banding patterns. The dashed rectangle identifies a Pause (2 seconds or longer of no speech). The white dots along the top third of the spectrogram indicate beeping medical equipment.

In FIG. 4B, frames 400(1) through 400(6) of the spectral data were extracted from spectrogram 400 using a two-second moving window passed over the spectral data in 0.5 second increments. Each two-second interval had 24 samples per second, resulting in a 48×300 array of spectral intensity values. Each 48 vectors (one vector per sample) were replicated three times to prevent the x-dimension from approaching zero during max pooling. The replicated vectors were placed directly adjacent to the corresponding original vector in the image. This resulted in a final input shape of 144×300 pixels. Each two-second frame 400(1) through 400(6) was assigned a binary label as shown in FIG. 4B: 0 if the frame had any speech and 1 if the frame contained no speech (a Pause). The first four frames all contain speech; the last two frames lie entirely within a Pause.

### II.F.3 CNN Model Card

The CNN model was designed to predict whether the two-second spectrogram images passed into the CNN classifier 224 contained any conversational speech or not (i.e., the two-second frame contained no speech—only a pause in the patient-clinician conversation).

### II.F.3.a Model Details

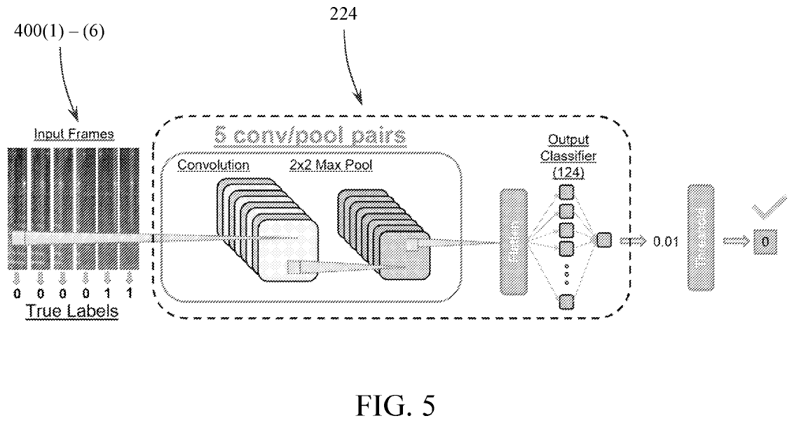

FIG. 5 shows an architecture overview of the CNN classifier 224. Two-second spectrogram frames, such as the frames 400(1) through 400(6) were fed into the first convolution layer. That information was propagated through the rest of the 4 sequential convolution/pooling pairs. The result of the last pooling layer was flattened and fed into a dense output classifier. In the example shown in FIG. 5, the CNN classifier 224 has correctly predicted the true label of the input frame.

In this example, the CNN classifier 224 was implemented using the Keras package in Python (Version 2.4.3) and had a total of 296,137 trainable parameters. The network (FIG. 5) consisted of five pairs of convolution and 2×2 max pooling layers followed by a dense output classifier. Each convolution layer used 3×3 filters having a stride of one. The first layer used 10 filters and all subsequent layers used 20 filters. Padding was not used. The output of the last convolution/pooling pair was flattened and used as input to a classifier comprising a dense layer having 128 units and a single output unit that used sigmoid activation. All other layers used Rectified Linear Unit (ReLU) activation. The Adam optimizer with default settings was used to adjust the training parameters between epochs.

### II.F.3.b Usage

The CNN model of the CNN classifier 224 required spectrograms 224S as inputs. For this work, the spectrogram data was stored in .csv files for easier access, and a data generator was implemented to load the spectral data for each training batch. The github repository contains three driver files. The driver custom-square-filter train-from-csv-LOOCV.py file trains the model using leave-one-out cross validation. The driver custom-square-filter train-from-csv.py file trains the model based on a user-defined training/validation split. The driver make-predictions only.py file loads trained model weights in order to make predictions.

### II.F.3.c Training Data

A subset of Acoustic Training Data was created from the audio recordings 204 of the first 31 study participants to train and cross-validate the CNN classifier 224. This subset represented 1,227 minutes of conversation containing 1,661 predicted pauses 236 of at least two seconds in length, all of which had been validated as ground truth Pauses by human coders. A second subset of Acoustic Testing Data was created using 6 audio recordings 204 (265 minutes of conversation time containing 213 total Pauses) not included in the Training Subset.

### II.F.3.d Training Duration

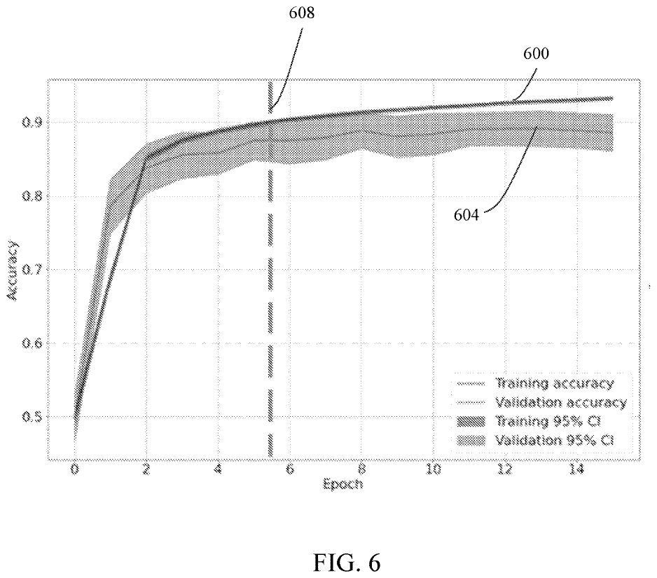

To preliminarily estimate the performance of the CNN classifier 224 during training and to select the model hyperparameters, leave-one-out cross validation was used on a per-patient basis (31 cross-validation models were trained with the data from a different patient held back for model evaluation). For each model training epoch, accuracy was calculated on both the training data and the data from the held-back patient. FIG. 6 plots the training accuracy 600 and validation accuracy 604 at each training epoch, and shows the curves diverging at approximately five epochs, suggesting the onset of overfitting. As a result, the weights of the CNN classifier 224 were fixed at five epochs for all subsequent work. Epoch 0 in FIG. 6 represents the CNN classifier 224 performance with initial random model weights before any training updates. Overfitting appears to have started somewhere between Epoch 5 and Epoch 8 (the point where the training and validation curves 600, 604 begin to diverge). The weights associated with Epoch 5 (marked with the dashed line 608) were fixed and used to generate the results provided in Table 1, above, and Tables 3A, 3B, 3C, 3D, 4A, 4B, and 4C, below.

### II.F.3.e Performance Evaluation

The RF classifier 220 performance in Pause prediction is shown in Table 3A.

TABLE 3A

| | | Ground Truth | | |
|---|---|---|---|---|
| | | Pause | Speech | |
| Random | Pause | 189 | 110 | 299 |
| Forest | Speech | 24 | 6,092 | 6,116 |
| | | 213 | 6,202 | 6,415 |

The CNN classifier 224 performance in Pause prediction is shown in Table 3B.

TABLE 3B

| | | Ground Truth | | |
|---|---|---|---|---|
| | | Pause | Speech | |
| Convolutional | Pause | 199 | 124 | 323 |
| | Speech | 14 | 6,078 | 6,092 |
| | | 213 | 6,202 | 6,415 |

The pause-detection classifier ensemble 216 performance in Pause prediction is shown in Table 3C.

TABLE 3C

| | | Ground Truth | | |
|---|---|---|---|---|
| | | Pause | Speech | |
| Ensemble | Pause | 186 | 91 | 277 |
| | Speech | 27 | 6,111 | 6,138 |
| | | 213 | 6,202 | 6,415 |

The summary of performance statistics for the RF classifier 220, CNN classifier 224, and pause-detection classifier ensemble 216 is shown in Table 3D.

TABLE 3D

| | | |
|---|---|---|
| Sensitivity | Random Forest | 189/213 = 88.7% |
| (Recall) | Convolutional | 199/213 = 93.4% |
| | Ensemble | 186/213 = 87.3% |
| Specificity | Random Forest | 6,092/6,202 = 98.2% |
| | Convolutional | 6,078/6,202 = 98.0% |
| | Ensemble | 6,111/6,202 = 98.5% |
| Negative Predictive | Random Forest | 6,092/6,116 = 99.6% |
| Value | Convolutional | 6,078/6,092 = 99.8% |
| | Ensemble | 6,111/6,138 = 99.6% |
| Positive Predictive | Random Forest | 189/299 = 63.2% |
| Value (Precision) | Convolutional | 199/323 = 61.6% |
| | Ensemble | 186/277 = 67.1% |
| F1 | Random Forest | 378/512 = 73.8% |
| | Convolutional | 398/536 = 74.3% |
| | Ensemble | 372/490 = 75.9% |

### II.F.4 Combining Random Forest (RF) and CNN Predictions

Combining predictions (outputs 220C and 224C) of the RF classifier 220 and the CNN classifier 224 improved Pause detection performance (details of training, validation, and testing of one example of a RF classifier 220 are described fully elsewhere). However, the RF classifier 220 and the CNN classifier 224 provided classification outputs 220C and 224C at different time scales. The RF classifier 220 estimated Pause versus Speech on 0.5-second non-overlapping intervals of the audio recordings 204. In contrast, the CNN classifier 224 classified Pauses versus Speech using 2-second overlapping frames of the spectrograms 224S.

To facilitate combining the outputs 220C and 224C of the RF classifier 220 and the CNN classifier 224, respectively, the CNN classifier 224 estimates were converted to 0.5-second, non-overlapping intervals. Next, thresholds were applied to the classification outputs 220C and 224C to obtain binary 0.5-second predictions of Pause vs. speech. The estimates of the RF classifier 220 and CNN classifier 224 were combined by retaining only those 0.5-second intervals where both the RF classifier 220 and the CNN classifier 224 agreed that no speech is present (“unanimous voting”).

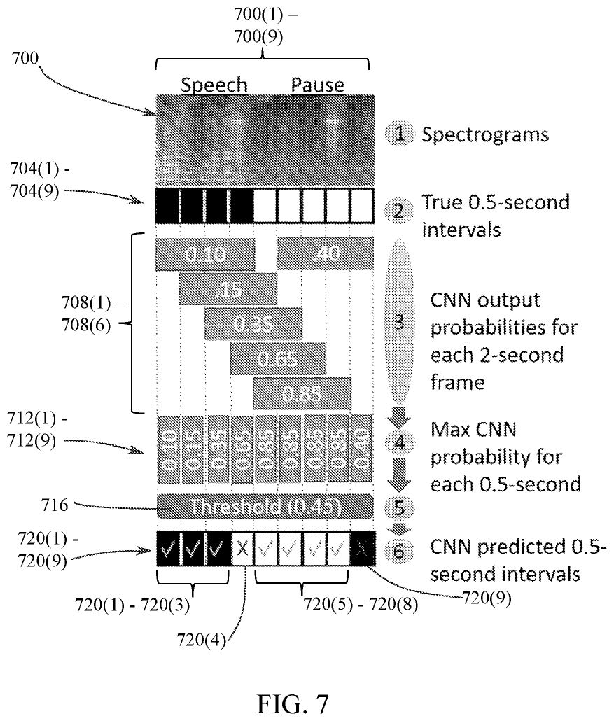

In FIG. 7, the process of converting the output probabilities of the CNN classifier 224 into predictions with 0.5-second resolution is shown. The spectrogram 700 was converted to 0.5-second audio segments 700(1) through 700(9), and associated true 0.5-second labels 704(1) through 704 (9) are shown for reference. The CNN classifier 224 generated probabilities 708(1) through 708(6) on 2-second moving windows, resulting in four predictions for each 0.5-second audio segment 700(1) through 700(9). The maximums 712(1) through 712(9) of these four predictions 708 was found for each of the 0.5-second segments 700(1) through 700(9). A threshold 716 of 0.45 was then applied to these maximums 712(1) through 712(9) to convert them into binary predictions 720(1) through 720(9) of pause vs. speech at a 0.5-second resolution. The check marks at binary predictions 720(1) through 720(3) and 720(5) through 720(8) show where the CNN classifier 224 correctly classified a 0.5-second interval (based on the true 0.5-second interval labels 704(1) through 704(9)), and the Xs at the binary predictions 720(4) and 720(9) show where the CNN classifier 224 incorrectly classified a 0.5-second interval. For example, in the fifth frame 700(5), there are four predictions 708: 0.15, 0.35, 0.65, and 0.85. The maximum 712(5) is 0.85, which is greater than the 0.45 threshold 716, so the CNN classifier 224 predicted a pause for frame 700(5). Since the true 0.5-second interval 704(5) also shows a pause, the CNN classifier 224 predicted correctly and a check mark 720(5) is shown.

Other methods for converting and merging the results of the RF classifier 220 and the CNN classifier 224 were investigated, and a series of Receiver Operating Characteristic (ROC) curves was used to select the optimal methods. A number of aggregating functions (e.g., Average, Mean, Thresholding each of the two-second windows, Majority vote) were explored. In one example the Max function produced the best ROC curve. The ROC curves were also used to select a point (corresponding to a pair of RF and CNN thresholds) that yielded a satisfactory balance of high detection of Connectional Silences with a low number of false predicted pauses 236.

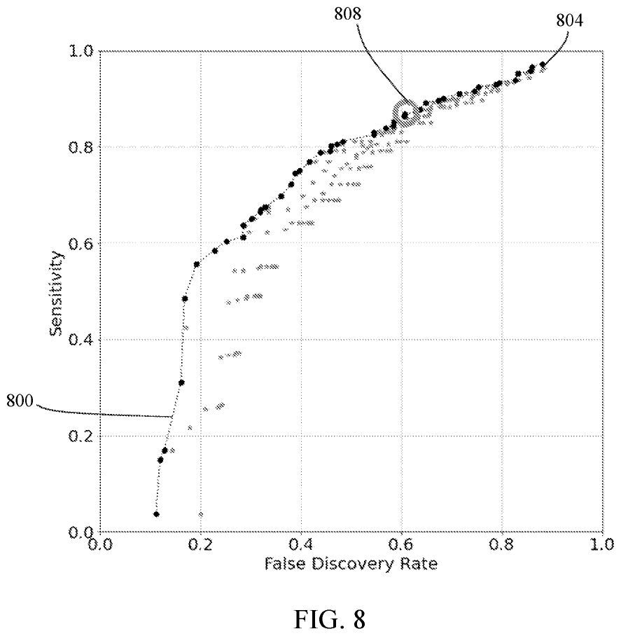

For example, in FIG. 8, an ROC curve shows the tradeoff between sensitivity and False Discovery Rate (the rate at which the pause-detection classifier ensemble 216 makes false predictions for predicted pauses 236; see also Table 3D and Table 4C, above) as the thresholds of the RF classifier 220 and the CNN classifier 224 were varied between 0.05 and 0.95. For each CNN/RF threshold pair on the non-dominated front 800 (black circles connected with dashed lines), there is no pair of thresholds that was better in terms of both Recall and False Discovery Rate. For example, the pair of thresholds 804 at the upper right portion of the non-dominated front has a very poor False Discovery Rate (close to 90%), but no other point has a better sensitivity. The circle 808 indicates the pair of thresholds (CNN threshold of 0.45 and a RF threshold of 0.425) used for subsequent prediction of Pause versus speech.

### II.F.5 Automated Transcription

The WHISPER™-Timestamped package was used as the ASR system 240 to automate transcription of the audio recordings 204. This package used the output of the WHISPER™ package to estimate a timestamp for the start and end of each word. The “medium” WHISPER™ model was used (https://huggingface.co/openai/whisper-medium). When the transcripts 232 were spot-checked against the audio recordings 204, the quality of the transcripts 232 and the accuracy of the timestamps were found to be acceptable; however, it was observed that the WHISPER™ model would occasionally “get stuck” and repeatedly predict phrases for substantial portions of the transcripts 232. These repeated phrases are a known weakness of the WHISPER™ model and are referred to as “hallucinations.” Setting the “condition_on_previous_text” flag to False helped reduce the number of hallucinations without noticeably sacrificing quality of transcripts 232. To further reduce the incidence of hallucinations, a method for identifying where these repeated phrases occurred was automated, and then these sections of the audio recordings 204 were automatically re-transcribed to remove the hallucinations.

### II.F.6 Training and Hyperparameter Selection of the BERT Classifier

A BERT classifier is an attention model, which is a class of neural networks that learns portion(s) of the sequence-to-sequence text most relevant to the current task (i.e., the model learns to focus “attention” on the most salient portions of the text). Attention models, pre-trained to understand the structure of language on enormous amounts of natural language data (e.g., encyclopedia entries, Internet forums and websites, research papers), can often be fine-tuned for a specific text classification task with a relatively limited amount of task-specific data. Attention models are widely used in the General Language Understanding Evaluation benchmark. In the present example, a Python ktrain wrapper was used for TensorFlow to implement the BERT classifier 228 that was pre-trained on the BooksCorpus dataset (800M words) and English Wikipedia (2,500M words).

The BERT classifier 228 was trained and tested using excerpts from automatically generated transcripts 232 of conversations, such as clinical conversations. Since most Deep Neural Networks (DNNs), BERT included, are sensitive to unbalanced training data, it can be beneficial to construct a training and testing dataset to minimize algorithmic bias, for example, one that is approximately balanced between the classifications of interest, for example, in the example described here, invitational, emotional, and non-connectional. In the current implementation, selections from the following three categories based on 13,439 Phase One 208 Pause predictions were as follows:
1) 231 Invitational: All Invitational Silences were selected (231 examples) because this was the least common sub-type.
2) 238 Emotional: To maximize the variety of patient-clinician conversations, up to seven of the Emotional sub-type per conversation were selected (these were randomly selected if there were more than seven within a given conversation). The number seven was chosen simply to provide enough samples (close to 231) to approximately balance the number of Invitational Silences.
3) 234 Non-Connectional: The approximate mean of the Emotional and Invitational sample counts (234) was then used as the target number of Non-Connectional Predictions. The Non-Connectional Predictions were sampled with a ratio of 39.7% true Non-Connectional Pauses to 60.3% falsely predicted Pauses to reflect the relative abundance of Non-Connectional Pauses and falsely predicted Pauses in the complete set of Ensemble predictions.

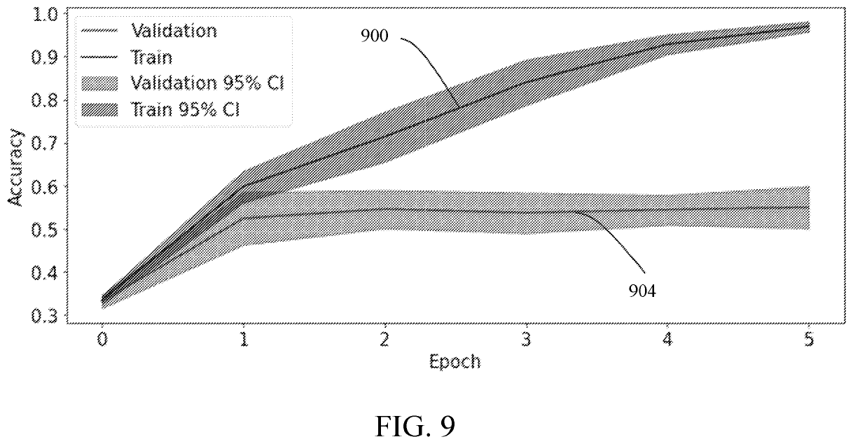

K-fold cross-validation (k=10) was used to train and evaluate each of the models. After each Epoch, accuracy was calculated on both the training and validation splits. FIG. 9 shows the training and validation accuracy of the BERT classifier 228 vs. training epoch. FIG. 9 shows that the BERT classifier 228 began overfitting after Epoch 1 (i.e., the training accuracy 900 continues to increase for all epochs, but the validation accuracy 904 plateaus after Epoch 1), and, so, weights were fixed at one training epoch for all analyses by the BERT classifier shown in this work.

### II.F.6.a Prediction Using Trained BERT Models

The ten-fold cross-validation method resulted in 10 trained models. To classify the predicted pauses 236 of the pause-detection classifier ensemble 216 not used for training (12,774 pauses in total), each of the 10 models was used to make predictions (i.e., 10 predictions for each pause), and then majority vote was used to produce a class prediction for each of the 12,774 pauses. Ties, such as when four models predicted Connectional and four models predicted non-connectional, were broken by choosing Connectional. Alternatively, when the tie was between Emotional and Invitational, ties were broken by random selection.

### II.F.7 Performance Evaluation

Performance of the BERT classifier 228 on classification of the 13,439 predicted pauses 236 from Phase One 208 are shown in Tables 4A, 4B, and 4C, below.

Table 4A, below, shows ConnectionalSilence sub-types collapsed.

TABLE 4A

| | | Ground Truth | | |
|---|---|---|---|---|
| | | Connectional | Non- | |
| | | Silence | Connectional | |
| BERT | Connectional | 453 | 9,455 | 9,908 |
| | Silence | | | |
| | Non- | 77 | 3,454 | 3,531 |
| | Connectional | | | |
| | | 530 | 12,909 | 13,439 |

Table 4B, below, shows Connectional Silence sub-types expanded.

TABLE 4B

| | | Ground Truth | | | |
|---|---|---|---|---|---|
| | | | | Non- | |
| | | Emotional | Invitational | Connectional | |
| BERT | Emotional | 207 | 46 | 5,798 | 6,051 |
| | Invitational | 43 | 157 | 3,657 | 3,857 |
| | Non- | 49 | 28 | 3,454 | 3,531 |
| | Connectional | | | | |
| | | 299 | 231 | 12,909 | 13,439 |

Table 4C, below, shows summary statistics measured relative to the total number of predictions of the pause-detection classifier ensemble 216.

TABLE 4C

| | | |
|---|---|---|
| Prevalence | Emotional | 299/13,439 = 2.2% |
| | Invitational | 231/13,439 = 1.7% |
| | Connectional | 530/13,439 = 3.9% |
| Sensitivity | Emotional | 207/299 = 69.2% |
| (Recall) | Invitational | 157/231 = 68.0% |
| | Connectional | 453/530 = 85.5% |
| Specificity | Emotional | 7,296/13,140 = 55.5% |
| | Invitational | 9,508/13,208 = 72.0% |
| | Connectional | 3,454/12,909 = 26.8% |
| Negative Predictive | Emotional | 7,296/7,388 = 98.8% |
| Value | Invitational | 9,508/9,582 = 99.2% |
| | Connectional | 3,454/3,531 = 97.8% |
| Positive Predictive | Emotional | 207/6,051 = 3.4% |
| Value (Precision) | Invitational | 157/3,857 = 4.1% |
| | Connectional | 453/9,908 = 4.6% |
| F1 | Emotional | 414/6350 = 6.5% |
| | Invitational | 314/4088 = 7.7% |
| | Connectional | 906/10,438 = 8.7% |

### II.F.7a Generating Collapsed Tables

Table 5A and Table 5B, below, help to visualize the process of moving from a confusion matrix with three pause types (Table 5A) to one that collapses the Emotional and Invitational Silences into one group (i.e., Connectional Silence); see Table 5B. Table 5A is an example Confusion Matrix listing all three types of pipeline predictions (Emotional Silences, Invitational Silences and Non-Connectional Pauses).

TABLE 5A

| | | Ground Truth | | |
|---|---|---|---|---|
| | | | | Non- |
| | | Emotional | Invitational | Connectional |
| Prediction | Emotional | A | A | B |
| | Invitational | A | A | B |
| | Non- | C | C | D |
| | Connectional | | | |

All entries of the same letter in Table 5A are summed and placed in the corresponding letter-coded cell of Table 5B. The example below uses combined Emotional and Invitational Connectional Silence as the true positives; equivalent calculations were performed with Emotional and Invitational Connectional Silences separately as the positive classes to facilitate calculation of the sensitivities and specificities for these classes.

TABLE 5B

| | | Ground Truth | |
|---|---|---|---|
| | | Connectional | Non- |
| | | Silence | Connectional |
| Prediction | Connectional | A | B |
| | Silence | | |
| | Non- | C | D |
| | Connectional | | |

### II.F.7b Formulas

Using Table 5B as an example, the formulas for sensitivity (recall), specificity, false discovery rate, negative predictive value, positive predictive value (precision), and F1 are as follows:

$$sensitivity ( recall ) = \frac{A}{A + C}$$

$$specificity = \frac{D}{B + D}$$

$$false discovery rate = \frac{B}{A + B}$$

$$negative predictive value = \frac{D}{C + D}$$

$$positive predictive value ( precision ) = \frac{A}{A + B}$$

$$F 1 = \frac{2 * A}{2 * A + B + C}$$

### III. Example Computing System

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission, such as encoded carrier waves and digitally pulsed signals.

Such software may also include information (e.g., data) carried as a data signal on a data carrier, such as a carrier wave or pulsed signal. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

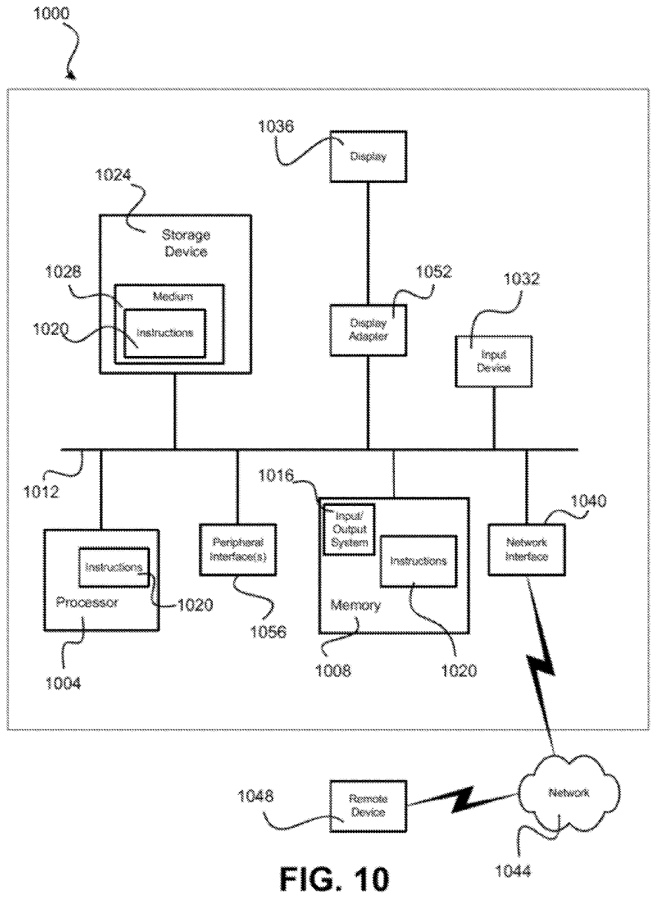

FIG. 10 shows a diagrammatic representation of one embodiment of a computing device in the exemplary form of a computer system 1000 within which a set of instructions for causing a system, such as any one or more or all elements of the conversation analytics system 100 of FIG. 1 or any one or more or all elements of the system 200S of FIG. 2, to perform any one or more of the aspects and/or methodologies of the present disclosure, including the methodologies described above relative to FIGS. 1 and 2, including the method 200M of FIG. 2. It is also contemplated that multiple computing devices may be utilized to implement a specially configured set of instructions for causing one or more of the devices to perform any one or more of the aspects and/or methodologies of the present disclosure. The computer system 1000 includes one or more processors (singly and collectively represented by element 1004) and memory 1008 of any one or more types that communicate with each other, and with other components, via one or more buses (singly and collectively represented by element 1012). The bus(es) 1012 may include any of one or more of several types of bus structures including, but not limited to, a memory bus, a memory controller, a peripheral bus, a local bus, and any combinations thereof, using any of a variety of bus architectures.

The memory 1008 may include various components (e.g., machine-readable media) including, but not limited to, a random access memory component, a read only component, and any combinations thereof. In one example, a basic input/output system 1016 (BIOS), including basic routines that help to transfer information between elements within computer system 1000, such as during start-up, may be stored in the memory 1008. The memory 1008 may also include (e.g., stored on one or more machine-readable media) instructions (e.g., software) 1020 embodying any one or more of the aspects and/or methodologies of the present disclosure. In another example, the memory 1008 may further include any number of program modules including, but not limited to, an operating system, one or more application programs, other program modules, program data, and any combinations thereof.

The computer system 1000 may also include one or more storage devices (singly and collectively represented by element 1024). Examples storage devices suitable for any one or more of the storage device(s) 1024 include, but are not limited to, a hard disk drive, a magnetic disk drive, an optical disc drive in combination with an optical medium, a solid-state memory device, and any combinations thereof. Each storage device 1024 may be connected to a corresponding bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, each storage device 1024 (or one or more components thereof) may be removably interfaced with computer system 1000 (e.g., via an external port connector (not shown)). Particularly, any storage device 1024 and an associated machine-readable medium 1028 may provide nonvolatile and/or volatile storage of machine-readable instructions, data structures, program modules, and/or other data for the computer system 1000. In one example, the software 1020 may reside, completely or partially, within the machine-readable medium 1028. In another example, the software 1020 may reside, completely or partially, within the processor(s) 1004.

The computer system 1000 may also include any one or more suitable input devices (singly and collectively represented by element 1032). In one example, a user of the computer system 1000 may enter commands and/or other information into computer system 1000 via any one or more input device 1032. Examples of input devices suitable for use as each input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Each input device 1032 may be interfaced to a corresponding bus 1012 via any of a variety of interfaces (not shown) including, but not limited to, a serial interface, a parallel interface, a game port, a USB interface, a FIREWIRE interface, a direct interface to the bus, and any combinations thereof. The input device 1032 may include a touch screen interface that may be a part of or separate from a display 1036, discussed further below. Each input device 1032 may be utilized as a user selection device for selecting one or more graphical representations in a graphical interface as described above.

A user may also input commands and/or other information to the computer system 1000 via any storage device 1024 (e.g., a removable disk drive, a flash drive, etc.) and/or network interface device 1040. A network interface device, such as network interface device 1040, may be utilized for connecting the computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as the network 1044, may employ a wired and/or a wireless mode of communication. In general, any network topology may be used. Information (e.g., data, software 1020, etc.) may be communicated to and/or from computer system 1000 via the network interface device(s) 1040.

The computer system 1000 may further include a video display adapter 1052 for communicating a displayable image to a display device, such as the display device 1036. Examples of a display device include, but are not limited to, a liquid crystal display (LCD), a cathode ray tube (CRT), a plasma display, a light emitting diode (LED) display, and any combinations thereof. The display adapter 1052 and the display device 1036 may be utilized in combination with the processor(s) 1004 to provide graphical representations of aspects of the present disclosure. In addition to a display device, the computer system 1000 may include one or more other peripheral output devices including, but not limited to, an audio speaker, a printer, and any combinations thereof. Such peripheral output devices may be connected to at least one of the one or more buses 1012 via one or more peripheral interfaces (singly and collectively represented by element) 1056. Examples of a peripheral interface include, but are not limited to, a serial port, a USB connection, a FIREWIRE connection, a parallel connection, and any combinations thereof.

Various modifications and additions can be made without departing from the spirit and scope of this disclosure. Features of each of the various embodiments and examples described above may be combined with features of other described embodiments and examples as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method of outputting an indication of a predicted pause in a conversation transformed into acoustical data, the method comprising:
receiving a plurality of forms of the acoustical data, wherein the forms are of differing types;
processing each of the plurality of forms with a corresponding form classifier so as to generate a corresponding plurality of pause-prediction outputs;
fusing the plurality of pause-prediction outputs with one another so as to generate an aggregated prediction of the predicted pause; and
outputting, as a function of the aggregated prediction, an indication of the predicted pause to a conversation analytics system.

2. The method of claim 1, wherein a first form of the plurality of forms comprises a plurality of audio features and a second form of the plurality of forms comprises image features.

3. The method of claim 2, wherein the audio features comprise mel-frequency cepstral coefficients and the acoustical data comprises a spectrogram.

4. The method of claim 1, wherein the pause is a conversational silence pause.

5. The method of claim 4, wherein the aggregated prediction is one or the other of a connectional silence pause and a non-connectional silence pause.

6. The method of claim 1, wherein a first form of the plurality of forms comprises a plurality of audio features.

7.-10. (canceled)

11. The method of claim 6, wherein a second form of the plurality of forms comprises a spectrogram.

12. The method of claim 1, wherein at least one form classifier comprises a machine-learning classifier.

13. The method of claim 12, wherein at least one form classifier comprises a convolutional neural network classifier.

14. The method of claim 1, wherein each form classifier is trained on training data configured to classify a pause of at least two seconds as a pause.

15. (canceled)

16. A method of classifying a pause in a conversation transformed into acoustical data, the method comprising:
processing each of a plurality of differing forms of the acoustical data with a corresponding form classifier so as to generate a corresponding plurality of pause-prediction outputs;
fusing the plurality of pause-prediction outputs with one another so as to generate a temporal location of a predicted pause within the conversation;
generating lexical data for a pre-pause segment of the conversation temporally adjacent to the predicted pause;
processing the lexical data with a lexical classifier to determine a predicted pause type for the predicted pause; and
outputting the predicted pause type to a conversation analytics system.

17.-25. (canceled)

26. The method of claim 16, wherein the conversation is a clinical conversation between a patient and a healthcare provider.

27.-29. (canceled)

30. The method of claim 16, wherein a first form of the plurality of forms comprises a plurality of audio features and a second form of the plurality of forms comprises image features.

31.-39. (canceled)

40. The method of claim 16, wherein at least one form classifier comprises a machine-learning classifier.

41. The method of claim 40, wherein at least one form classifier comprises a convolutional neural network classifier.

42.-45. (canceled)

46. A method, comprising:
processing each of a plurality of differing forms of the acoustical data with a corresponding form classifier so as to generate a corresponding plurality of pause-prediction outputs;
fusing the plurality of pause-prediction outputs with one another so as to generate a temporal location of a predicted pause within the conversation;
generating lexical data for a pre-pause segment of the conversation temporally adjacent to the predicted pause;
processing the lexical data with a lexical classifier to determine a predicted pause type for the predicted pause; and
outputting the predicted pause type to a conversation analytics system;
wherein processing the audio data includes:
processing each of a plurality of forms of the audio data with a corresponding form classifier so as to generate a corresponding plurality of pause-prediction outputs;
fusing the plurality of pause-prediction outputs with one another so as to generate an aggregated prediction of the pause; and
outputting, as a function of the aggregated prediction, an indication of the pause to the lexical analyzer.

47. The method of claim 46, wherein a first form of the plurality of forms comprises a plurality of audio features and a second form of the plurality of forms comprises image features.

48. (canceled)

49. (canceled)

50. The method of claim 46, wherein:
the pause is a conversational silence pause; and
the aggregated prediction is one or the other of a connectional silence pause and a non-connectional silence pause.

51.-56. (canceled)

57. The method of claim 46, wherein at least one form classifier comprises a machine-learning classifier.

58. The method of claim 57, wherein at least one form classifier comprises a convolutional neural network classifier.

59.-77. (canceled)
